(19) United States
(12) Patent Application Publication
(10) Pub. No.: US 2006/0265977 A1
(43) Pub. Date: Nov. 30, 2006

(54) Window sill

(76) Inventor: John A. Powers JR., Phoenix, AZ (US)

Correspondence Address: ROBERT A. PARSONS, 4000 N. CENTRAL AVENUE, SUITE 1220, PHOENIX, AZ, 85012, US

(21) Appl. No.: 11/138,186

(22) Filed: May 26, 2005

(51) Int. Cl. E06B 3/00

(52) U.S. Cl. 52/204.5

(57) ABSTRACT

A window sill includes a metal form having inner and outer surfaces and a shape defining an inner space. The window sill also includes a foam material region positioned in the inner space so that an upper surface of the foam material region is adjacent to and forms a seal with the inner surface of the metal form. The window sill further includes a window assembly for holding a pane of glass. The window sill is positioned on and forms a seal with the outer surface of the metal form.

### BACKGROUND OF THE INVENTION

1. Field of the Invention

This invention relates generally to masonry construction and, more particularly, to window sills for use in masonry construction.

2. Related Art and Prior Art Statement

Prior art masonry construction typically includes a window in a masonry wall. The construction of the window is generally accomplished by defining the bottom of a window opening in the wall and then positioning a window frame thereon. The masonry wall is built around the window frame to define upright sides and the top of the window opening. A window sill is placed on the bottom and between the sides of the window frame. A window assembly is positioned on the window sill and a pane of glass is positioned on the assembly so that the pane occupies the window opening.

There are several problems, however, with prior art masonry construction. One problem is that moisture can accumulate on the pane of glass and flow downwards to the window assembly and the window sill. The moisture can pool up and undesirably flow into and/or through the window assembly and window sill, or it can even flow into the masonry wall. The moisture can cause mold and mildew to grow and can also decrease the lifetime of the window sill and masonry wall because it can cause rotting. Another problem with prior art masonry construction is that they typically are not insulated enough. Hence, hot or cold air can undesirably infiltrate the masonry wall and the window sill. Accordingly, it is desirable to provide new masonry construction that provides a better barrier to moisture and air.

### BRIEF SUMMARY OF THE INVENTION

The present invention provides a window sill which includes a metal form having inner and outer surfaces and a shape defining an inner space. The window sill also includes a foam material region positioned in the inner space so that an upper surface of the foam material region is adjacent to and forms a seal with the inner surface of the metal form. The window sill further includes a window assembly for holding a pane of glass. The window assembly is positioned on and forms a seal with the outer surface of the metal form.

The present invention also provides a window sill incorporated in a masonry construction. The masonry construction includes a masonry wall defining an upper surface. The window sill is carried on and forms a seal with the upper surface of a masonry wall. The window sill includes a metal form having inner and outer surfaces and a shape defining an inner space. The inner space of the metal form is defined by a first wall, integrally formed first and second sidewalls extending downwardly therefrom the first wall, a second wall extending from the second sidewall, and a third sidewall extending downwardly therefrom the second wall. A foam material region is positioned in the inner space so that an upper surface of the foam material region is adjacent to and forms a seal with the inner surface of the metal form.

The present invention further provides a method of installing a window sill. The method includes providing a masonry wall with an upper surface; providing a window sill on the upper surface of the masonry wall; and providing a window assembly for holding a pane of glass on the window sill. The window sill includes a foam material region positioned on the upper surface of the masonry wall so that it forms a seal therewith and a metal form having inner and outer surfaces and a shape defining an inner space. The foam material region is received by the inner space so that an upper surface of the foam material region is adjacent to and forms a seal with the inner surface of the metal form. The window assembly is positioned on and forms a seal with an outer surface of the metal form.

These and other features, aspects, and advantages of the present invention will become better understood with reference to the following drawings, description, and claims.

### BRIEF DESCRIPTION OF THE DRAWINGS

Referring to the drawings:

FIG. 1 is a simplified exploded perspective view of a window sill in accordance with the present invention;

FIG. 2 is a simplified exploded perspective view of a masonry construction which includes the window sill of FIG. 1 and a masonry wall; and

FIG. 3 is a simplified end view of the masonry construction of FIG. 2.

### DETAILED DESCRIPTION OF THE INVENTION

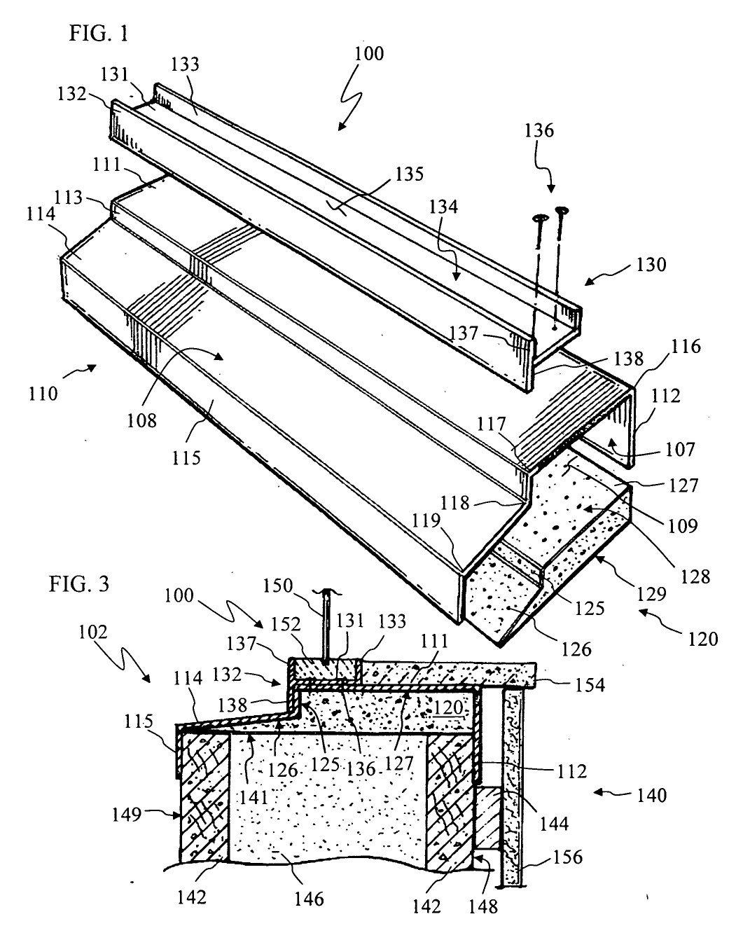

FIG. 1 is a simplified exploded perspective view of a window sill 100 in accordance with the present invention. It should be noted that like reference characters indicate corresponding elements throughout the several view. Window sill 100 has several advantages which make it useful. For example, window sill 100 is light in weight so it can be easily moved from one location to another. This is particularly useful because window sills are typically incorporated into a masonry construction where they are positioned above ground level to span the bottom of a window frame. Hence, window sill 100 is easier to work with because its light weight makes it easier and less cumbersome to lift up and position. Another advantage of window sill 100 is that it provides a better barrier to moisture. This decreases the amount of water related problems typically associated with window sills, such as mold and mildew growth and rotting. Window sill 100 also provides a better barrier to the flow of hot and cold air therethrough so that it has better insulative properties. This is desirable for a number of reasons, such as to reduce utility bills. Finally, there is more flexibility in choosing the appearance of window sill 100 so that the end user can choose an appearance that is esthetically pleasing to him or her.

In one embodiment, window sill 100 includes a metal form 110 having inner and outer surfaces 107 and 108 and a shape defining an inner space 109. Window sill 100 also includes a foam material region 120 positioned in inner space 109 so that an upper surface 128 of foam material region 120 is adjacent to and forms a seal with inner surface 107 of metal form 110. Window sill 100 further includes a window assembly 130 for holding a pane of glass (not shown). Window assembly 130 is positioned on and forms a seal with outer surface 108 of metal form 110. The various seals are formed to reduce the undesirable flow of moisture and/or air between the interfaces of the components. The moisture can be from rain, condensation, etc. that comes into contact with sill 100.

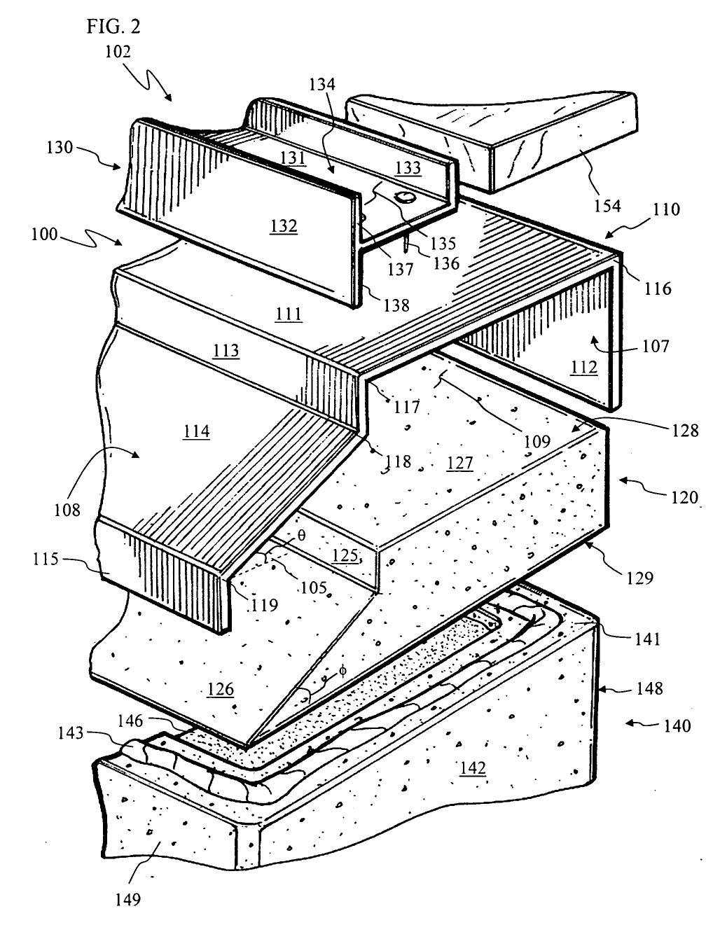

In this embodiment, metal form 110 includes a wall 111 with integrally formed sidewalls 112 and 113 which extend downwardly from it at bends 116 and 117, respectively. Metal form 110 also includes an integrally formed wall 114, which extends from wall 113 at a bend 118. Further, an integrally formed sidewall 115 extends downwardly from wall 114 at a bend 119. In this example, sidewalls 112 and 115 are designed to be positioned in the interior and exterior, respectively, of the masonry construction, as will be discussed in more detail in conjunction with FIGS. 2 and 3. Inner space 109 of metal form 110 is defined by walls 111 and 114, along with sidewalls 112, 113, and 115. It should be noted that inner and outer surfaces 107 and 108 extend over opposed sides of walls 111-115.

It should also be noted that metal form 110 can be constructed in many different ways and provided with many different shapes and sizes. In this example, metal form 110 is fabricated by bending an elongated metal sheet (preferably steel) longitudinally to form bends 116-119. Bends 116, 117, and 119 are bent at substantially 900 angles relative to surface 111 and bend 118 is bent so that wall 114 is oriented at a non-zero angle relative to wall 111, as will be discussed in more detail in FIG. 3. It should be noted, however, that walls 111 and 114 can be substantially parallel in other examples. Wall 114 is angled downwardly relative to wall 111 in this example so that moisture on wall 114 flows down it towards sidewall 115. Further, in other examples, walls 111-115 can be bent or curved, but are shown as being straight and flat in this embodiment for illustrative purposes.

It will of course be understood that this particular embodiment of forming metal form 110 is only one method and other methods and structures will occur to those skilled in the art. For example, all of the bends and shapes in metal form 110 can be formed simultaneously or substantially at the same time, or the metal sheet can be extruded with the desired form. Further, in this example, metal form 110 can be formed in standard or general lengths in many different ways. In one way, metal form 110 can be fabricated with a particular length which can later be cut to a desired length by the end user.

In this embodiment, foam material region 120 includes upper surface 128 and an opposed lower surface 129. Upper surface 128 includes a surface 127, a surface 125 extending downwardly from surface 127, and a surface 126 extending from surface 125. Here, surface 127 is substantially parallel and surface 125 is substantially perpendicular to surface 129. In this example, surface 126 extends from surface 125 at an angle relative to surface 127, as will be discussed in more detail in FIG. 3. However, in other examples, surfaces 126 and 127 can be substantially parallel. The angle between surfaces 126 and 127 is substantially the same as the angle between surfaces 111 and 114, for reasons to be discussed presently.

In this embodiment, foam material region 120 is positioned adjacent to metal form 110 so that surfaces 125, 126, and 127 are adjacent to walls 113, 114, and 111, respectively. Hence, foam material region 120 and metal form 110 have complementary shapes so that they can be positioned together to provide a seal therebetween. It should be noted that this seal can be facilitated by using an adhesive material, such as glue, positioned on surfaces 107 and/or 128. In some embodiments, metal form 110 is flexible and foam material region 120 is rigid so that form 110 can be bent to conform to the shape of foam material region 120. In this way, the shape of inner surface 107 is adjustable so that metal form 110 can be shaped to conform to the shape of upper surface 128 of foam material region 120. This provides the end user flexibility in choosing the appearance of window sill 100 so that the end user can choose an appearance that is esthetically pleasing to him or her.

A foam material is generally a porous material that is light in weight, yet still strong and resilient. A porous material is one which has many cells or voids throughout its structure. The cells can be open so that they communicate with each other or they can be closed and filled with a gas, such as air. In this embodiment, the cells are preferably closed to reduce the amount of moisture and/or air that flows therethrough foam material region 120. Examples of foam materials include a “polymeric foam” which are polymeric materials that have been expanded in a known manner so as to form a porous material. Examples of polymeric foams include polyurethane foam, Styrofoam, and other conventional expandable polymeric foams. The foam material can also include additives such as fillers, fibers, or other additives which affect properties such as strength, weight, expansion, setting, finish, etc. However, the composition and material properties of the foam material is typically chosen for its insulative and moisture barrier properties.

The foam material can be applied or formed through conventional techniques or processes. The foam material can be applied in prefabricated configurations with a desired shape, size, and length so that it will fill a desired portion of inner space 109. In this embodiment, metal form 110 and foam material region 120 are prefabricated and shaped so that foam material region 120 occupies substantially all of inner space 109. In other embodiments, metal form 110 can be prefabricated in a desired shape and foam material region 120 can be sprayed or injected into inner space 109 and onto inner surface 107 so that it conforms to the shape of metal form 110. Material region 120 is then left to cure or harden so that it occupies inner space 109.

In this embodiment, window assembly 130 is positioned on outer surface 108 of metal form 110. Window assembly 130 has a wall 131 fastened to outer surface 108 of metal form 110 with fasteners 136. In this particular example, fasteners 136 extend through walls 131 and 111 and fastens them together to form a seal therebetween. It should be noted, however, that assembly 130 can be fastened to metal form 110 in other ways which also forms a seal, such as with an adhesive or a clamp. Assembly 130 has sidewalls 132 and 133 which extend vertically along a longitudinal axis and from opposite longitudinal edges of wall 131. In this example, sidewalls 132 and 133 are coupled to wall 131 so that they form a T-shape and an L-shape, respectively, therebetween.

In this example, wall 133 extends above and perpendicular to an upper surface 134 of wall 131. Further, wall 132 has a wall portion 137 which extends above and perpendicular to surface 134. Wall 132 also has a wall portion 138 which extends below and perpendicular to surface 134 so that it is adjacent to and forms a seal therewith sidewall 113 of metal form 110. This seal can be facilitated by using an adhesive material, such as glue, in some examples. Upper surface 134 of wall 131, along with opposed faces of wall portion 137 and wall 133 define a trench 135 for receiving a pane of glass (not shown). It should be noted that window assembly 130 can have other structures, shapes, and configurations, but it is shown here as described above for illustrative purposes. For example, wall portion 137 and wall 133 are perpendicular to wall 131 so that trench 135 has a rectangular cross-sectional shape (FIG. 3) in a direction perpendicular to the longitudinal axis of wall 131. However, in other examples, wall portion 137 and walls 131 and 133 can be curved or otherwise shaped to provide a different cross-sectional shape.

Turn now to FIG. 2 which is a simplified exploded perspective view of a masonry construction 102, which includes window sill 100 of FIG. 1 and a masonry wall 140, and FIG. 3 which is a simplified end view of window sill 100 and masonry wall 140 of FIG. 2. In this embodiment, masonry wall 140 includes a masonry block 142. It should be noted that masonry wall 140 typically includes more than one masonry block 142, but only one block is shown here for simplicity. In this example, masonry block 142 is the type having opposed vertical side walls or faces, and webbing extending horizontally between the vertical side walls. Masonry block 142 is made of standard material known in the art, such as molded concrete, but it will be understood that any of the other well-known masonry materials, such as bricks, stones, bricks, or wood can also be used.

In this embodiment, masonry block 142 defines an inner volume which receives grout/mortar material 146 therein. Grout is generally used to fill cracks and/or crevices in masonry and mortar includes any of various bonding materials used in masonry. These materials are typically used in surfacing and plastering and can include a plastic mixture of cement or lime, sand, and water which hardens in place to bind together the masonry material. Here, it will be understood that grout, mortar, or any convenient masonry binding material, is herein referred to as grout/mortar. A convenient masonry binding material is generally a non-porous, hydraulic, and/or cementitious material and is typically chosen for it ability to bind, as well as block the flow of moisture and/or air therethrough.

It should be noted that in some embodiments, portions of the inner volume defined by block 142 can be empty, but in this embodiment, the volume is occupied with grout/mortar material 146 for illustrative purposes and to provide a better barrier to the flow of moisture and/or air. Further, it should also be noted that in normal masonry construction, it may not be necessary to completely fill all of blocks 142 with grout/mortar material 146. However, it has been found that the strength of blocks 142 substantially increases as the amount of grout/mortar in block 142 is increased. In some embodiments, solid masonry, such as solid blocks, bricks, or stones, can be used instead of masonry blocks 142. In addition, the steps of laying mortar and filling the openings with grout/mortar can be performed in any desired order that is convenient for the specific application and the type of masonry materials used.

In this example, masonry block 142 has an upper peripheral surface 141 which extends around the inner volume. An adhesive material 143 is positioned on surface 141 and surface 129 of foam material region 120 is positioned on surface 141 so that foam material region 120 is coupled to block 142. In this way, grout/mortar material 146 is adjacent to lower surface 129 of foam material region 120 and forms a seal therewith. Metal form 110 is then positioned over foam material region 120 as discussed above in conjunction with FIG. 1. It should be noted that window sill 100, and the other components discussed herein, can be installed in masonry construction 102 in many other different ways. For example, foam material region 120 can be positioned in inner space 109 of metal form 110 and then they can both be moved into position so that they are carried by block 142 on surface 141.

In accordance with the invention, metal form 110 is positioned so that sidewalls 112 and 115 extend over opposed sides 148 and 149, respectively, of block 142 and form a seal therewith. In this way, moisture and/or air is less likely to penetrate through the interface between block 142 and metal form 110, as well as the interface between grout/mortar material 146 and foam material region 120. In some examples, the respective seals between sidewalls 112, 115 and sides 148, 149 can be facilitated by using an adhesive material, such as glue.

In this embodiment, a furring 144 is positioned on surface 148 of block 142. Furring 144 is for the preparation of masonry wall 140 to provide a level substratum for the positioning of window sill 100 and to act as a fastening piece for a wall board 156. Wall board 156 is positioned adjacent to furring 144 so that it is aligned substantially parallel to surface 148 of block 142 and extends up to about the same level as wall 111 of metal form 120. Wall board 156 can include materials typically used in the construction of walls, such as drywall, wood, bricks, etc.

Window assembly 130 is positioned on surface 108 and fastened to wall 111 with fasteners 136 as described above in conjunction with FIG. 1. In this particular example, a holder 152 is positioned in trench 135 (See FIGS. 1 and 2) and holds a pane of glass 150 in an upright position. Holder 152 is preferably made of a material which is impervious to the flow of moisture and air. It should be noted, however, that window assembly 130 can hold pane of glass 150 in other ways. For example, in some examples, pane of glass 150 can be wide enough to substantially occupy all of trench 135 so that it is held in place by walls 131, 133, and wall portion 137 and forms a seal therewith. In some examples, an adhesive can be used to form a better seal between holder 152, window assembly 130, and/or pane of glass 150.

A sill member 154 is positioned on surface 108 of wall 111 so that it abuts sidewall 133 and extends to wall board 156. Preferably, sill member 154 has a shape chosen to form a seal with sidewall 133, wall 111, and wall board 156 to reduce the flow of moisture and/or air therebetween. Hence, sill member 154 typically includes a material which is impervious to the flow of moisture and/or air. In some examples, sill member 154 is held in place with an adhesive material so that it forms a better seal between it and sidewall 133, wall 111, and wall board 156. Sill member 154 can include a material to add decorative features to masonry construction 102. For example, it can include marble, brick, stone, wood, or another material which provides a desired esthetic appearance. In this embodiment, sill member 154 can be easily positioned and removed from masonry construction 140. Since sill member 154 can be easily positioned and removed from masonry construction 140, the end user has flexibility in choosing the appearance of window sill 100 so that the end user can choose an appearance that is esthetically pleasing to him or her.

In this example, wall 114 is at a non-zero angle θ relative to surface 111 (FIG. 2) so it is angled downwardly. Angle θ is the angle between wall 114 and a reference line 105 which extends from bend 119 in a direction parallel to surface 111. In this way, water incident to window assembly 130, pane of glass 150, holder 152, and/or wall 114 will flow towards sidewall 115. Since sidewall 115 overlaps side 149 of block 142, the water will flow away from the interface of surfaces 129 and 141 and down block 142 so that it remains in the exterior of wall construction 140. Further, surfaces 126 and 127 are oriented at an angle φ relative to each other so that surface 126 is angled downwardly (FIG. 2). Angle φ is the angle between surface 126 and 129, where surface 129 is parallel to surface 127. Typically, angle 0 is substantially the same as angle φ so that surface 126 is adjacent to inner surface 107 of wall 114 and forms a seal therewith.

Thus, window sill has several advantages which makes it useful. Window sill 100 is light in weight because it includes foam material region 120, so it can be easily moved from one location to another. Window sill 100 also provides a better barrier to moisture or condensation because sill 100 is shaped so that water flows away from window assembly 130 and towards wall 115. In this way, the moisture or condensation will be less likely to pool up and undesirably flow into and/or through the interface between window sill 100 and masonry construction 102. This decreases the amount of water related problems typically associated with window sills, such as mold and mildew growth and rotting. Window sill 100 also provides a better seal to the flow of air therethrough. This is desirable to produce better insulation and reduce utility bills.

Various modifications and changes to the embodiments herein chosen for purposes of illustration will readily occur to those skilled in the art. For example, form 110 and/or the window sill can be fabricated in a variety of ways while still performing the stated functions. Further, a variety of different masonry materials may be utilized and the walls may be fabricated in a variety of somewhat modified and/or interchanged steps.

The foregoing is given by way of example only. Other modifications and variations may be made by those skilled in the art without departing from the scope of the invention as defined by the following claims.

Having fully described and disclosed the present invention and preferred embodiments thereof in such clear and concise terms as to enable those skilled in the art to understand and practice same, the invention claimed is:

1. A window sill, comprising:
a metal form having inner and outer surfaces and a shape defining an inner space; and
a foam material region positioned in the inner space, an upper surface of the foam material region being adjacent to the inner surface of the metal form.

2. The sill of claim 1, further including a window assembly for holding a pane of glass, the window assembly being positioned on the outer surface of the metal form.

3. The sill of claim 1, wherein the metal form has opposed downwardly extending sidewalls for overlapping opposite sides of a masonry wall.

4. The sill of claim 1, wherein the metal form is of a flexible sheet metal held rigid by the foam material region.

5. The sill of claim 1, wherein the foam material region has a shape complementary to the shape of the metal form.

6. The sill of claim 1, wherein the inner space of the metal form is defined by a first wall, integrally formed first and second sidewalls extending downwardly therefrom the first wall, a second wall extending from the first sidewall, and a third sidewall extending downwardly therefrom the second wall.

7. The sill of claim 6, wherein the first and second walls are oriented at a non-zero angle relative to each other.

8. A window sill incorporated in a masonry construction, comprising:
a masonry wall with an upper surface;
a window sill carried by and sealed to the upper surface of the masonry wall, the window sill including
a metal form having inner and outer surfaces and a shape defining an inner space, the inner space of the metal form being defined by a first wall, integrally formed first and second sidewalls extending downwardly therefrom the first wall, a second wall extending from the second sidewall, and a third sidewall extending downwardly therefrom the second wall; and
a foam material region positioned in the inner space and sealed to the inner surface of the metal form.

9. The sill of claim 8, further including a window assembly positioned on and sealed to the outer surface of the metal form, the window assembly defining a trench for receiving a pane of glass.

10. The sill of claim 8, wherein the metal form is flexible and conforms to the shape of the foam material region.

11. The sill of claim 8, furthering including masonry binding material in the masonry wall, the masonry binding material being adjacent to and forming a seal with a lower surface of the foam material region.

12. The sill of claim 8, wherein the first and third downwardly extending sidewalls are adjacent to and sealed with opposite sides of the masonry wall.

13. The sill of claim 8, wherein an upper surface of the foam material region has a first surface portion, a second surface portion extending downwardly from the first surface portion, and a third surface portion extending from the second surface portion.

14. The sill of claim 8, wherein the shape of an upper surface of the foam material region is chosen to conform to the inner surface of the metal form.

15. A method of installing a window sill, comprising:
providing a masonry wall with an upper surface;
providing a window sill on the upper surface of the masonry wall, the window sill being sealed to the upper surface of the masonry wall, the window sill including
a foam material region positioned on the upper surface of the masonry wall,
a metal form having inner and outer surfaces and a shape defining an inner space, the foam material region being received by the inner space, an upper surface of the foam material region being adjacent to and sealed with the inner surface of the metal form; and
providing a window assembly for holding a pane of glass, the window assembly being positioned on and sealed with the outer surface of the metal form.

16. The method of claim 15, wherein the inner space of the metal form is defined by a first wall, integrally formed first and second sidewalls extending downwardly therefrom the first wall, a second wall extending from the second sidewall, and a third sidewall extending downwardly therefrom the second wall.

17. The method of claim 16, wherein the step of providing the window sill includes positioning the first and third sidewalls on opposite sides of the masonry wall.

18. The method of claim 15, wherein the step of providing the window sill includes positioning the foam material region in the inner space of the metal form before the window sill is positioned on the upper surface of the masonry wall.

19. The method of claim 15, further including bending the shape of the metal form to conform to a shape of the foam material region.

20. The method of claim 16, wherein the first and second walls are oriented at a non-zero angle relative to each other.
